(19) United States
(12) Patent Application Publication
(10) Pub. No.: US 2011/0111769 A1
(43) Pub. Date: May 12, 2011

(54) MOBILE TERMINAL AND CONTROLLING METHOD THEREOF

(76) Inventor: Kyu Cheol Yeon, Seoul (KR)

(21) Appl. No.: 12/882,256

(22) Filed: Sep. 15, 2010

(30) Foreign Application Priority Data
Nov. 10, 2009 (KR) 10-2009-0107945

(51) Int. Cl. H04W 24/00; H04M 1/00

(52) U.S. Cl. 455/456.1; 455/556.1

(57) ABSTRACT

A mobile terminal and controlling method thereof are disclosed, which facilitates a terminal to be used in further consideration of user's convenience. According to at least one of embodiments of the present invention, it is able to provide a terminal user with information indicating whether a pre-registered counterpart exists in a preview image displayed in the course of image photographing. The present invention includes displaying a camera preview image and if information on a current location of the mobile terminal is obtained, displaying a counterpart indicator in the camera preview image based on the current location of the mobile terminal. In this case, the counterpart indicator indicates that at least one pre-registered counterpart exists within the camera preview image.

Pursuant to 35 U.S.C. §119(a), this application claims the benefit of earlier filing date and right of priority to Korean Application No. 10-2009-0107945, filed on Nov. 10, 2009, the contents of which are hereby incorporated by reference herein in their entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for facilitating a terminal to be used in further consideration of user's convenience.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

Recently, the mobile terminal is equipped with a camera module and can be widely utilized for moving and/or still picture photographing functionality. Therefore, many efforts need to be made to research and develop a method of using a camera preview image, which is provided by the camera module to capture a moving and/or still picture, in order to provide a user with various kinds of informations on an object within the camera preview image.

### SUMMARY OF THE INVENTION

Accordingly, the present invention is directed to a mobile terminal and controlling method thereof that substantially obviate one or more problems due to limitations and disadvantages of the related art.

An object of the present invention is to provide a mobile terminal and controlling method thereof, by which a camera preview image provided by a camera module to capture a moving and/or still picture can be used to provide a user with various kinds of informations on an object within the camera preview image.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal according to the present invention includes a user input unit, a wireless communication unit, at least one camera module, a touchscreen configured to display a camera preview image, a position-location module configured to obtain information on a current location of the mobile terminal, and a controller controlling a counterpart indicator to be displayed in the camera preview image based on the current location of the mobile terminal. In this case, the counterpart indicator indicates that at least one pre-registered counterpart exists within the camera preview image.

In another aspect of the present invention, a method of controlling a mobile terminal according to the present invention includes displaying a camera preview image and if information on a current location of the mobile terminal is obtained, displaying a counterpart indicator in the camera preview image based on the current location of the mobile terminal. In this case, the counterpart indicator indicates that at least one pre-registered counterpart exists within the camera preview image.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to one embodiment of the present invention;

FIG. 2A is a front perspective diagram of a mobile terminal according to one embodiment of the present invention;

FIG. 2B is a rear perspective diagram of a mobile terminal according to one embodiment of the present invention;

FIG. 3 is a diagram of an environment for implementing a mobile terminal controlling method according to an embodiment of the present invention;

FIG. 4 is a flowchart for a mobile terminal controlling method according to an embodiment of the present invention; and

FIGS. 5 to 14 are diagrams of display screen configurations for implementing a mobile terminal controlling method according to an embodiment of the present invention.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile terminals, such as mobile phones, user equipment, smart phones, mobile computers, digital broadcast terminals, personal digital assistants, portable multimedia players (PMP) and navigators.

However, by way of non-limiting example only, further description will be with regard to a mobile terminal 100, and it should be noted that such teachings may apply equally to other types of terminals.

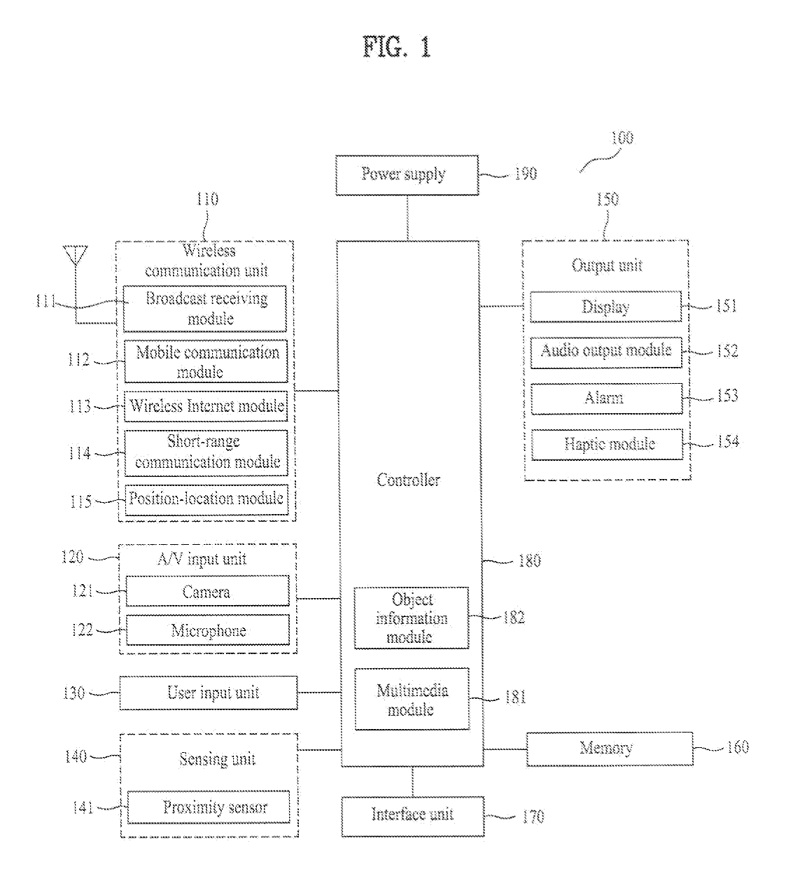

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

At least two broadcast receiving modules 111 can be provided to the mobile terminal 100 in pursuit of simultaneous receptions of at least two broadcast channels or broadcast channel switching facilitation.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.). Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN(Wireless LAN) (Wi-Fi), Wibro (Wireless broadband), Wimax (World Interoperability for Microwave Access), HSDPA(High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The mobile terminal 100 is able to search and obtain necessary object information in a manner of accessing an external server having an object information database via the wireless internet access. Moreover, the mobile terminal 100 is able to search and download a personal material or information (e.g., photo, etc.) of a pre-registered counterpart in a manner of accessing an SNS (social network service) website for the pre-registered via the wireless internet access for example.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, a haptic module 154, a projector module 155 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor (not shown in the drawing) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

In the following description, for clarity, an action that a pointer approaches without contacting with the touchscreen to be recognized as located on the touchscreen is named ‘proximity touch’. And, an action that a pointer actually touches the touchscreen is named ‘contact touch’. The meaning of the position on the touchscreen proximity-touched by the pointer means the position of the pointer which vertically opposes the touchscreen when the pointer performs the proximity touch.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory unit 160 can store the database relating to object information of an object (e.g., building, shop, milestone, etc.) that can be searched using at least one of shape recognizing information related to the object within an image photographed by the camera and position information of the mobile terminal 100 obtained through the position-location module. The object information can include at least one of relevant text information (e.g., a name of the building, a name of the shop, etc.), relevant link information (e.g., link information of the building, link information of the shop, etc.), relevant image information (e.g., an image logo of the building, an image logo of the shop, etc.) (non-limited to them) and audio information (e.g., a logo song of the building, a logo song of the shop, etc.), of the shape recognized object.

The database stored in the memory unit 160 can be updated or downloaded from a database of an external server via the wireless communication unit. The database of the memory unit 160 can include the data constructed in a manner of downloading every part of the database of the external server. Alternatively, the database of the memory unit 160 can include the data constructed in a manner of downloading a portion of the database of the external server in consideration of the capacity of the memory unit 160. The portion of the database of the external server may be provided for an object located within a predetermined distance from a current location of the terminal or may be provided for an object located in a predetermined area (e.g., an administrative district) related to the current location of the terminal.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The controller 180 is able to identify a prescribed image part of a prescribed image (e.g., a camera preview image, a play image) through the shape recognizing processing.

Meanwhile, the controller 180 can be configured to implement augmented reality (abbreviated AR). The augmented reality is a sort of virtual reality that combines a real world seen through user's eyes and a virtual world having side information into one image. Namely, the augmented reality, which complements a real world with a virtual world, plays a role in providing information necessary for the real world additionally using graphics. The controller 180 is able to display the object information in form of the augmented reality.

The controller 180 can be provided with an object information module 182 for the processing related to a display of the object information. The object information module 182 can be implemented within the controller 180 or be being separated from the controller 180.

The controller 180 is able to control the wireless communication unit 100 to receive location information of a terminal of a counterpart pre-registered with the phonebook or a specific group in the phonebook for example. The terminal of the counterpart may be occasionally expressed as the “counterpart terminal” or simply “counterpart”. The counterpart terminal directly provides its location information to the mobile terminal 100. Alternatively, a mobile communication network, with which the counterpart terminal has been registered, obtains location information of the counterpart terminal and then provides the obtained location information to the mobile terminal 100.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

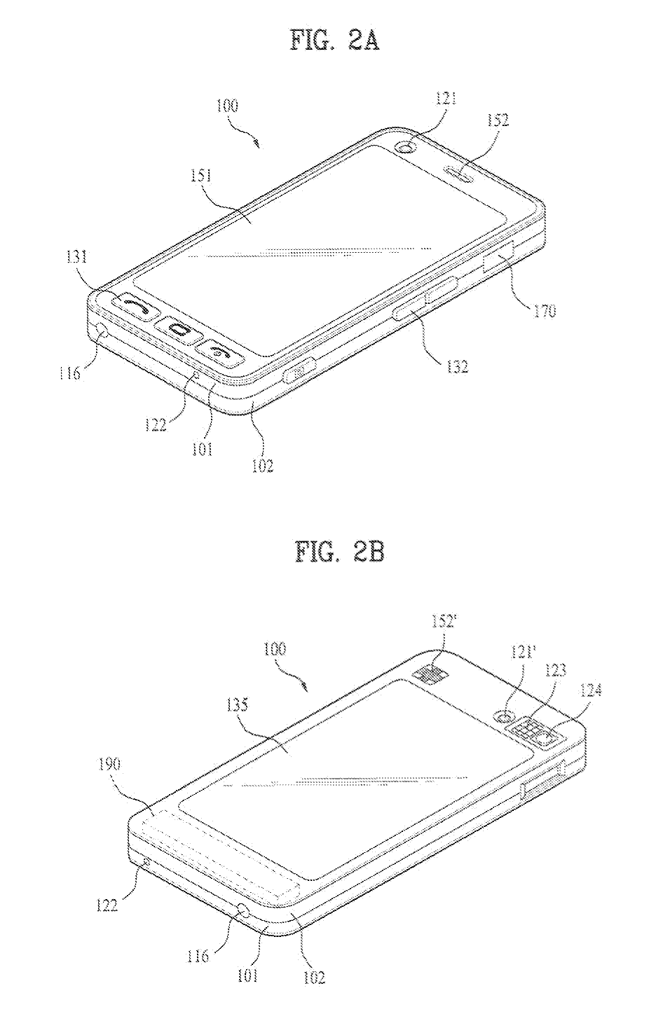

FIG. 2A is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2A, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

FIG. 2B is a perspective diagram of a backside of the terminal shown in FIG. 2A.

Referring to FIG. 2B, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up. Of course, the camera 121′ of the rear case 102 is usable for a video call.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2A and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display 151. In this case, if the display 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

In the following description, embodiments related to a controlling method, which can be implemented in the mobile terminal 100, are explained with reference to the accompanying drawings.

If the display module 151 includes a touchscreen, implementation of the following embodiment is further facilitated. Therefore, the following description is made on the assumption that the display module 151 includes a touchscreen. And, a display screen of the touchscreen 151 is indicated by a reference number 400 in the following description.

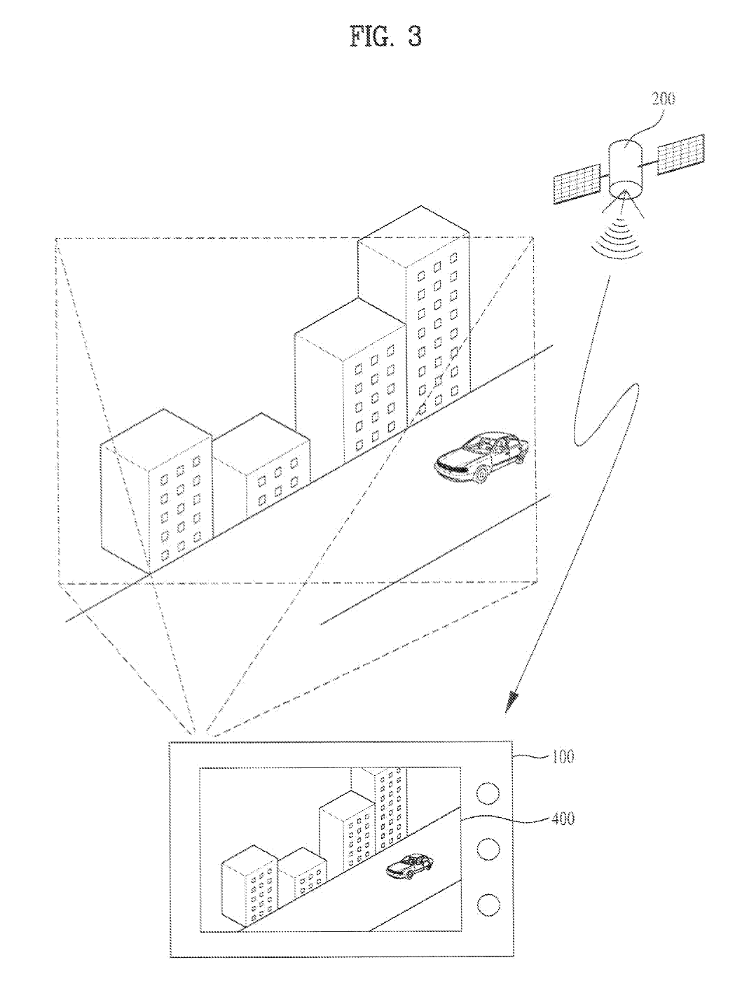

FIG. 3 is a diagram of an environment for implementing a mobile terminal controlling method according to an embodiment of the present invention.

Referring to FIG. 3, the mobile terminal 100 is able to photograph a peripheral image as a preview image (hereinafter named a camera preview image) via the camera module 121. The mobile terminal 100 is then able to display the camera preview image on the touchscreen 400.

The mobile terminal 100 is able to receive at least one (hereinafter named location information) of latitude, longitude, altitude and direction of the mobile terminal 100 from a satellite 200 via the position-location module 115.

The mobile terminal 100 is able to receive location information of a counterpart terminal previously registered with the phonebook or a specific group of the phonebook via the wireless communication unit 110 for example. In particular, the counterpart terminal may directly provide its location information to the mobile terminal 100. Alternatively, a mobile communication network, with which the counterpart terminal is registered (or subscribed), may obtain the location information of the counterpart terminal and then provide the obtained location information to the mobile terminal 100.

Using the location information of the mobile terminal 100 and the location information of the counterpart terminal, the controller 180 controls a counterpart indicator, which indicates whether a counterpart (i.e., the counterpart terminal) is located within the camera preview image, to be displayed on the touchscreen 400.

If the counterpart is located within the camera preview image, it may mean that the counterpart exists in a range of a photographing angle of the camera module to photograph the camera preview image. A zoom level of the camera module 121 can be further used in order to render the counterpart indicator to be displayed in the camera preview image.

In case that the counterpart exists in the camera preview image, shape (or pattern) recognition information of the counterpart is further usable in association with displaying the counterpart terminal.

In the following description, ‘displaying the counterpart indicator’ is further explained in detail.

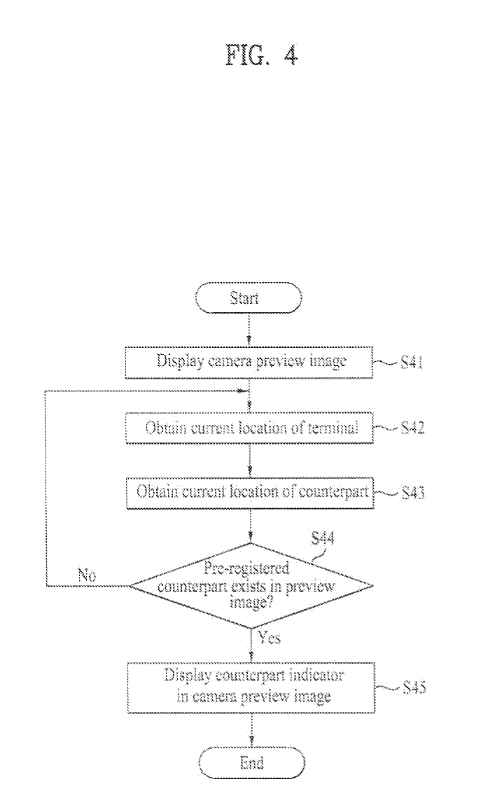

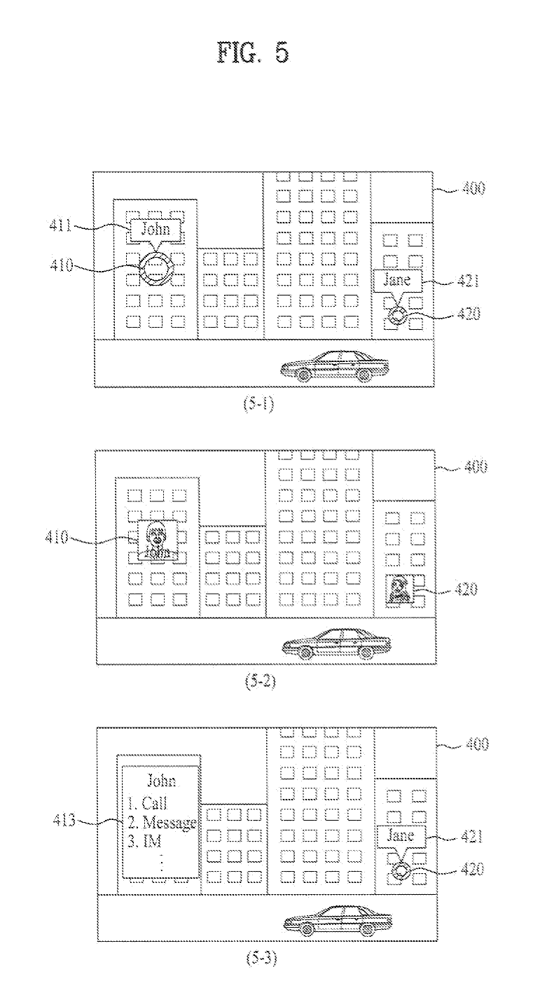

FIG. 4 is a flowchart for a mobile terminal controlling method according to an embodiment of the present invention, and FIGS. 5 to 14 are diagrams of display screen configurations for implementing a mobile terminal controlling method according to an embodiment of the present invention.

Referring to FIG. 5 (5-1), the camera preview image is being displayed on the touchscreen 400 [S41].

In doing so, the controller 180 is able to obtain current location information of the mobile terminal 100 via the position-location module 115 [S42].

Afterwards, the controller 180 is able to receive current location information of a counterpart previously registered with the phonebook or a specific group of the phonebook via the wireless communication unit 110 for example [S43].

Optionally, the steps S41 to S43 can be performed simultaneously or in a reverse order.

In consideration of both of the current location information of the mobile terminal 100 and the current location information of the counterpart, the controller 180 checks whether the counterpart exists within the camera preview image [S44]. In checking whether the counterpart exists within the camera preview image, the controller 180 s able to further consider a zoom level of the camera module 121.

In case of determining that the counterpart does not exist to correspond to the camera preview image, the controller 180 keeps updating the current location information of the mobile terminal 100 or the current location information of the counterpart to check whether the mobile terminal 100 or the counterpart has moved to a new location.

On the contrary, in case of determining that the counterpart exists to correspond to the camera preview image, referring to FIG. 5 (5-1), the controller 180 is able to display a counterpart indicator indicating that the counterpart exists or is located within the camera preview image [S45]. In this case, it is not mandatory for the counterpart to be actually seen in the camera preview image. For example, the counterpart may be hidden behind a building in the camera preview image. However, the counterpart indicator can be displayed in a manner of corresponding to a location at which the counterpart exists in the camera preview image. Therefore, a user of the mobile terminal 100 is facilitated to recognize by intuition that the counterpart is located in a predetermined direction with reference to a user's location by referring to the counterpart indicator. Moreover, the user of the mobile terminal 100 is also facilitated to recognize whether the counterpart is located at a spot higher or lower than the user's spot.

FIG. 5 (5-1) exemplarily shows that a first counterpart indicator 410 indicating that a first counterpart exists within the camera preview image and a second counterpart indicator 420 indicating that a second counterpart exists within the camera preview image are displayed. The first and second counterpart indicators 410 and 420 can further include name informations 411 and 421 of the corresponding counterparts, respectively.

The first and second counterpart indicators 410 and 420 can be displayed in a manner of being distinguished from each other according to a distance for the corresponding counterpart to be spaced apart from the mobile terminal 100.

For instance, referring to FIG. 5 (5-1), if a first spaced distance for the first counterpart to be spaced apart from the mobile terminal 100 is less than a second spaced distance for the second counterpart to be spaced apart from the mobile terminal 100, the first counterpart indicator 410 can be displayed bigger than the second counterpart indicator 420.

Meanwhile, it is not mandatory for the spaced distance to be represented as a size of the counterpart indicator. For instance, the spaced distance can be represented as a color or shape of the counterpart indicator. Optionally, the counterpart indicator can further include the spaced distance information represented as numeral(s) [not shown in the drawing].

In case that the first and second counterparts belong to different groups of the phonebook, respectively, the first and second counterpart indicators 410 and 420 can be displayed in a manner of being visually distinguished from each other [not shown in the drawing].

Referring to FIG. 5 (5-2), the first and second counterpart indicators 410 and 420 can be displayed as photos of counterparts registered with the phonebook of the mobile terminal 100, respectively. In this case, the counterpart photo can be registered in a manner of being stored in the phonebook or linked to a photo album for the phone book. If the counterpart photo is not registered with the phonebook, the controller 180 is able to display the counterpart photo in a manner of downloading the counterpart photo by accessing a preset website via the wireless communication unit 110. In this case, the website can include SNS (social network service) website.

It is able to select a prescribed one of the first and second counterpart indicators 410 and 420 (e.g., the first counterpart indicator 410). The selection of the first counterpart indicator 410 can be performed by a proper manipulation of the user input unit. For instance, the first counterpart indicator 410 can be selected by being long-touched on the touchscreen 400.

If so, referring to FIG. 5 (5-3), a menu list 413 including menus relevant to the first counterpart is displayed.

In particular, menus currently executable on the first counterpart can be included in the menu list 413. Alternatively, menus currently executable on the first counterpart are displayed by being activated (or highlighted), while menus currently not executable on the first counterpart are displayed by being deactivated (or non-highlighted).

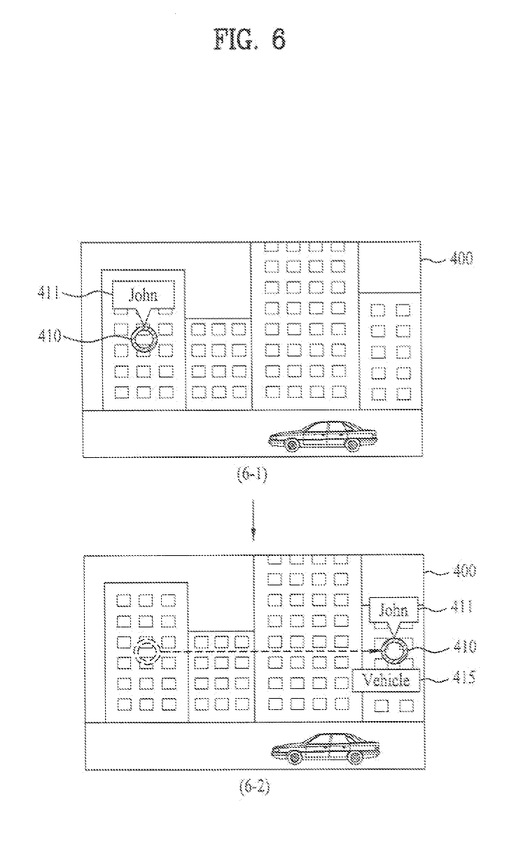

In the following description, FIG. 6 is explained.

Referring to FIG. 6 (6-1), the first counterpart indicator 410 is being displayed in the camera preview image. Referring to FIG. 6 (6-2), when the first counter part is moving, the first counterpart indicator 410 can be displayed in the camera preview image in a manner of moving to correspond to the moving first counterpart.

In doing so, the controller 180 is able to calculate a moving speed of the first counterpart using location information of the first counterpart, which varies per a unit time interval.

Based on the calculated moving speed, the controller 180 is able to estimate whether the first counterpart is moving on foot or by vehicle. Thus, the controller 180 is able to estimate a moving means of the first counterpart.

Referring to FIG. 6 (6-2), the first counterpart indicator 410 can include moving means information 415 based on the estimated moving means of the first counterpart. Moreover, the first counterpart indicator 410 can further include the calculated moving speed information represented as numerals (e.g. 60 km/h) together with or instead of the moving means information 415 [not shown in the drawing].

The camera preview image having the counterpart indicator displayed thereon can be entirely captured according to a proper manipulation of the user input unit 130. In particular, both of the counterpart indicator and the camera preview image can be captured together. For instance, the proper manipulation of the user input unit 130 can include a shutter manipulation for photographing or capturing the camera preview image. While the entirely captured camera preview image is displayed, the controller 180 can prevent unnecessary power consumption by deactivating the camera module 121 (e.g., interrupting a power supply).

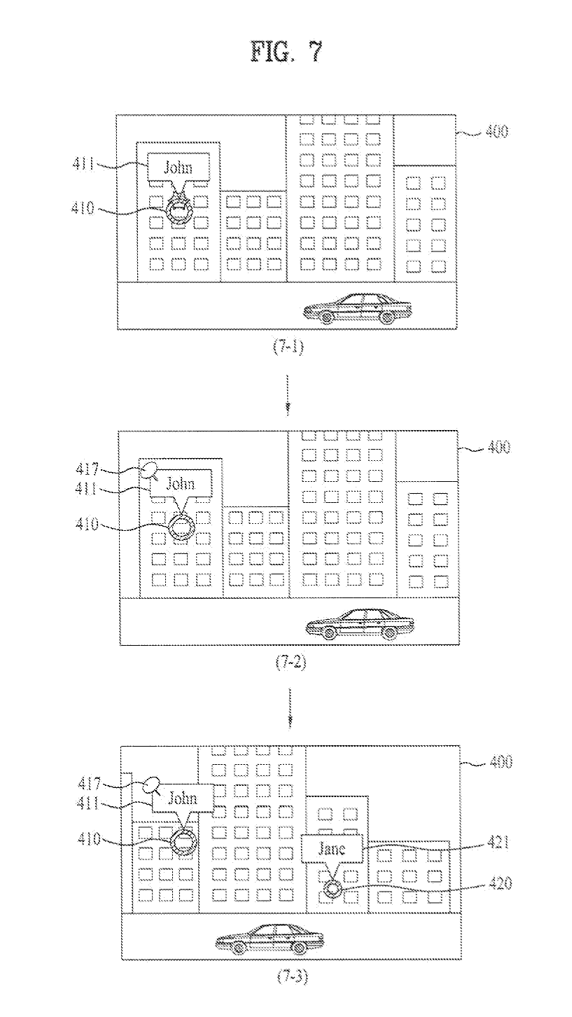

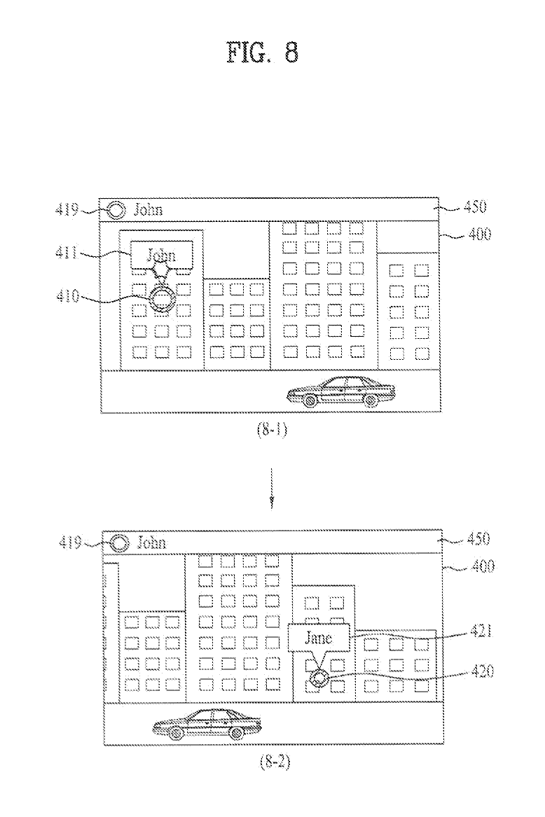

If necessary, the controller 180 is able to selectively capture the counterpart indicator from the camera preview image only. This is further described with reference to FIG. 7 and FIG. 8 as follows.

Referring to FIG. 7 (7-1), the camera preview image is displayed on the touchscreen 400. And, the first counterpart indicator 410 is displayed in the camera preview image.

In this case, a user command for capturing the first counterpart indicator 410 can be inputted via the user input unit 130. For example, the user command can include a double-touch performed on the first counterpart indicator 410.

If so, referring to FIG. 7 (7-2), the first counterpart indicator 410 is captured from the camera preview image only. Moreover, the first counterpart indicator 410 can further include a capture indicator 417 indicating that it is captured.

A direction faced by the camera module 121 can be adjusted in a manner of adjusting an orientation direction by panning the mobile terminal 100 for example. In this case, referring to FIG. 7 (7-3), a new camera preview image according to the adjustment of the direction faced by the camera module 121 can be displayed on the touchscreen 400. Yet, the captured first counterpart indicator 410 can be displayed at the original position on the touchscreen 410 as it is.

In case that a second counterpart may be newly located in the new camera preview image, a second counterpart indicator 420 can be displayed at a corresponding point in the new camera preview image.

Therefore, if a prescribed one of the first counterpart indicator 410 and the second counterpart indicator 420 is selected, a menu list for a counterpart corresponding to the prescribed indicator can be displayed.

When the counterpart indicator is captured, it is not mandatory for the captured counterpart indicator to be fixed to the original position on the touchscreen. This is further explained in detail with reference to FIG. 8 as follows.

As mentioned in the foregoing description with reference to FIG. 7 (7-1), when the first counterpart indicator 410 is captured, referring to FIG. 8 (8-1), it is able to display a first counterpart capture indicator 419, which indicates that the first counterpart indicator 410 has been captured, on a separate capture region 450 of the touchscreen 400.

In FIG. 8 (8-1), the separate first counterpart capture indicator 419 can be displayed together with the first counterpart indicator 410, by which the present embodiment is non-limited. Optionally, when the separate first counterpart capture indicator 419 is displayed, the first counterpart indicator 410 may not be displayed.

In case that both of the first counterpart indicator 410 and the separate first counterpart capture indicator 419 are allowed to be displayed together, the first counterpart may not be located within the new camera preview image due to the new orientation direction, for example, adjusted by panning the mobile terminal 100. In this case, the first counterpart indicator 410 may not be displayed within the new camera preview image.

However, even if the first counterpart indicator 410 is not displayed within the new camera preview image, the first counterpart capture indicator 419 may still be display in the capture region 450. Thus, when the first counterpart capture indicator 419 in the capture region 450 is selected, a menu list for the first counterpart can be displayed.

In FIG. 7 or FIG. 8, a specific counterpart (or its indicator) within the camera preview image is selected and captured, by which the present embodiment is non-limited. For instance, when the camera preview image is being displayed on the touchscreen, a shutter manipulation for photographing the camera preview image can be performed. If so, the camera preview image is stored in the memory 160 and all counterparts within the camera preview image are captured to be displayed on the separate capture region of the touchscreen.

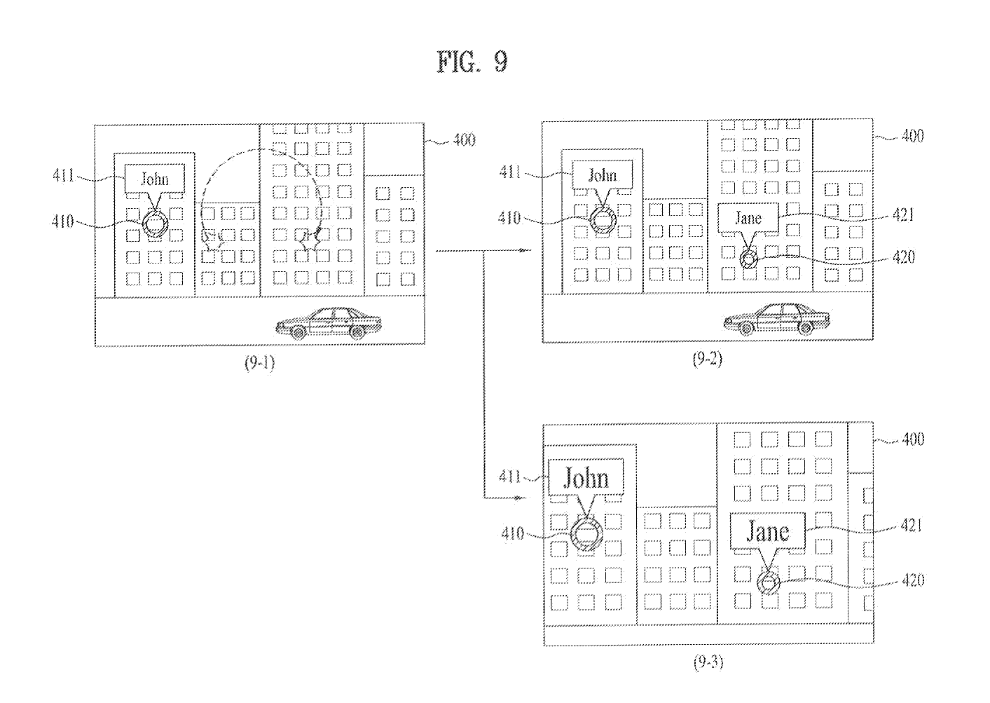

The following description is made with reference to FIG. 9.

First of all, even if the counterpart is located within the camera preview image, an indicator of the counterpart may be displayed depending on a distance between the mobile phone 100 and the counterpart. That is, even if the counterpart is located within the camera preview image, an indicator of only the counterpart which is spaced apart from the mobile terminal 100 in a prescribed distance can be displayed in the camera preview image. In this case, the prescribed distance is adjustable according to a terminal user's setup.

For instance, assume that the prescribed distance is set to a first distance. If so, referring to FIG. 9 (9-1), a first counterpart indicator 410 of a first counterpart spaced apart within the first distance can be displayed within the camera preview image.

Meanwhile, the first prescribed distance can be adjusted into a second distance farther than the first distance. The adjustment of the prescribed distance can be performed through a proper manipulation of the user input unit 130. FIG. 9 (9-1) exemplarily shows that the prescribed distance is adjusted into the second distance from the first distance if a touch & drag is performed on the touchscreen circularly and clockwise. Of course, the prescribed distance can be adjusted from the second distance into the first distance if a touch & drag is performed on the touchscreen circularly and counterclockwise [not shown in the drawing].

If so, referring to FIG. 9 (9-2), indicators 410 and 420 of counterparts spaced apart from the mobile terminal 100 within the second distance among a plurality of counterparts located within the camera preview image, i.e., indicators of first and second counterparts, can become displayed within the camera preview image.

Alternatively, referring to FIG. 9 (9-3), if a touch & drag is performed on the touchscreen 400 circularly and clockwise, the camera preview image can be further zoomed in. And, indicators 410 and 420 of first and second counterparts spaced apart from the mobile terminal 100 within the second distance can be displayed within the zoomed-in camera preview image. Of course, if a touch & drag is performed on the touchscreen 400 circularly and counterclockwise, the camera preview image can be zoomed out [not shown in the drawing].

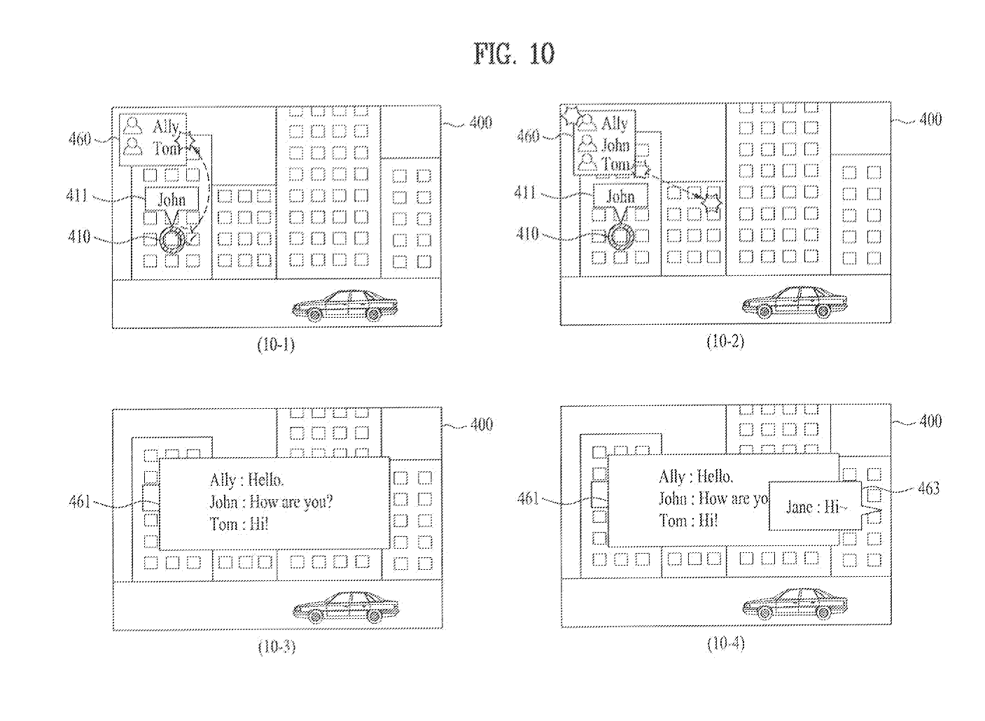

The following description is made with reference to FIG. 10. FIG. 10 shows that an instant message function is performed on counterparts located within the camera preview image.

Referring to FIG. 10 (10-1), it is able to display an instant message list 460 within the camera preview image. In this case, the instant message list 460 can be generated through a proper manipulation of the user input unit. Alternatively, the instant message list 460 can be generated if a corresponding touch gesture is performed on the touchscreen 400.

A first counterpart indicator 410 displayed in the camera preview image is touched with such a pointer as a finger, a stylus pen and the like and can be then dragged to the instant message list 460.

If so, the controller 180 enables a first counterpart to be included in the instant message list 460.

Subsequently, referring to FIG. 10 (10-2), a prescribed first touch gesture can be performed on the instant message list 460. Although no limitation is put on the first touch gesture, FIG. 10 (10-2) exemplarily shows that the first touch gesture is performed in a manner of touching two points of the instant message list simultaneously and then spreading the touched two points.

If so, an instant messaging can be performed together with counterparts activated within the instant message list. FIG. 10 (10-3) exemplarily shows that a window 461 for the instant messaging is displayed.

In the course of the instant messaging, a deactivated counterpart in the instant message list is newly activated. The newly activated counterpart can attempt to perform the instant messaging on the mobile terminal 100. In this case, assume that the activated counterpart is not located within the preview image.

If so, referring to FIG. 10 (10-4), a new icon or window 463 for displaying the attempted instant messaging can be displayed separate from the former instant message window 461.

In this case, the new instant message icon 463 can be arranged on the touchscreen 400 in a manner of facing a direction in which the activated counterpart is located relative to the mobile terminal 100.

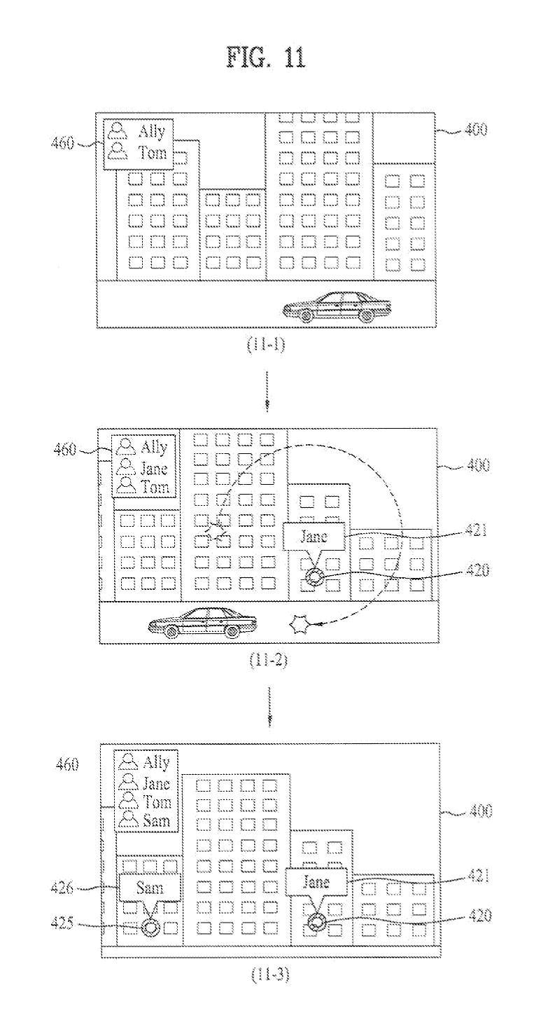

FIG. 10 shows that a specific one of counterparts within the camera preview image is selected and then included in the instant message list, by which the present embodiment is non-limited. Alternatively, all counterparts displayed within the camera preview image can be included in the instant message list. This is explained in detail with reference to FIG. 11 as follows.

Referring to FIG. 11 (11-1), the camera preview image can be displayed on the touchscreen 400. And, an instant message list 460 can be displayed on the touchscreen 400.

As the orientation direction is adjusted by panning the mobile terminal 100 for example, a direction faced by the camera module 121 can be adjusted. In this case, referring to FIG. 11 (11-2), a new camera preview image according to the adjusted direction faced by the camera 121 can be displayed on the touchscreen 400. Even if the new camera preview image is displayed, the instant message list 460 can keep being displayed.

As the mobile terminal 100 is panned, if a second counterpart spaced apart from the mobile terminal 100 within a first distance newly appears in the new camera preview image, referring to FIG. 11 (11-2), the controller 180 can control a second counterpart indicator 420 to be displayed at a corresponding location.

Referring to FIG. 11 (11-2), when the second counterpart newly appears in the camera preview image, the controller 180 is able to control the second counterpart to be automatically registered with the instant message list 460.

A touch gesture for zooming in the camera preview image can be performed on the touchscreen 400. As mentioned in the foregoing description, the touch gesture can include a touch & drag performed on the touchscreen 400 circularly and clockwise.

If so, referring to FIG. 11 (11-3), the controller 180 is able to control the zoomed-in camera preview image to be displayed on the touchscreen 400.

As the camera preview image is zoomed in, the controller 180 controls indicators 420 and 425 of all counterparts (i.e., second and third counterparts), each of which is spaced apart from the mobile terminal 100 in a second distance greater than the first distance, within the zoomed-in camera preview image to be displayed at corresponding positions in the camera preview image, respectively. In particular, as the camera preview image is zoomed in, the third counterpart indicator 425 is newly displayed in the counterpart indicator.

Referring to FIG. 11 (11-3), when the third counterpart newly appears in the camera preview image, the controller 180 controls the third counterpart to be automatically registered with the instant message list 460.

As mentioned in the foregoing description, if a corresponding touch gesture is performed on the instant message list 460, it is able to perform an instant message communication with the counterparts in the list.

When the camera preview image having the instant message list included therein is displayed in FIG. 10 or FIG. 11, a shutter manipulation for photographing the camera preview image is performed to capture the camera preview image. And, the captured camera preview image can be stored as a photo file in the memory 160. In doing so, information on the counterparts in the instant message list can be stored as meta information in the photo file together.

Therefore, when a terminal user opens the stored photo file in the mobile terminal, the controller 180 is able to control to re-initiate the instant message communication with the stored counterparts. Alternatively, when the instant message communication is initiated after the stored photo file is opened, the controller 180 displays a list of the stored counterparts and then controls to perform the instant message communication with prescribed counterparts selected from the stored counterparts by the terminal user.

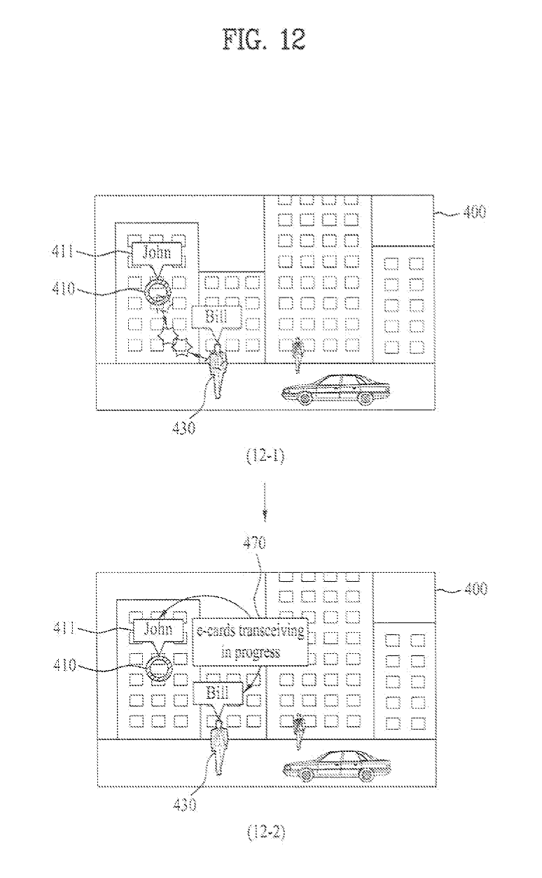

The following description is made with reference to FIG. 12.

Referring to FIG. 12 (12-1), assume that a third one of the pre-registered counterparts is actually seen without being blocked by other objects such as a building in the camera preview image.

If so, an indicator 430 of the third counterpart actually seen from the camera preview image (i.e., a third counterpart indicator 430) can be displayed in the camera preview image in a manner of being visually distinguishable from an indicator 410 of a first counterpart not actually seen from the camera preview image (i.e., a first counterpart indicator 410).

FIG. 12 (12-1) exemplarily shows that the third counterpart indicator 430 is an outline frame enclosing the third counterpart.

A prescribed second touch gesture can be performed on the first counterpart indicator 410 and the third counterpart indicator 430. In this case, the second touch gesture can include a gesture performed in a manner that both of the first and second counterpart indicators 410 and 420 are simultaneously touched and then dragged close to each other.

If so, business cards of the first and third counterparts can be transceived between a first counterpart terminal and a second counterpart terminal. In particular, the first and third counterparts can be introduced to each other by the second touch gesture. In the camera preview image, it is able to display an indicator 470 indicating that the electronic business cards are transceived.

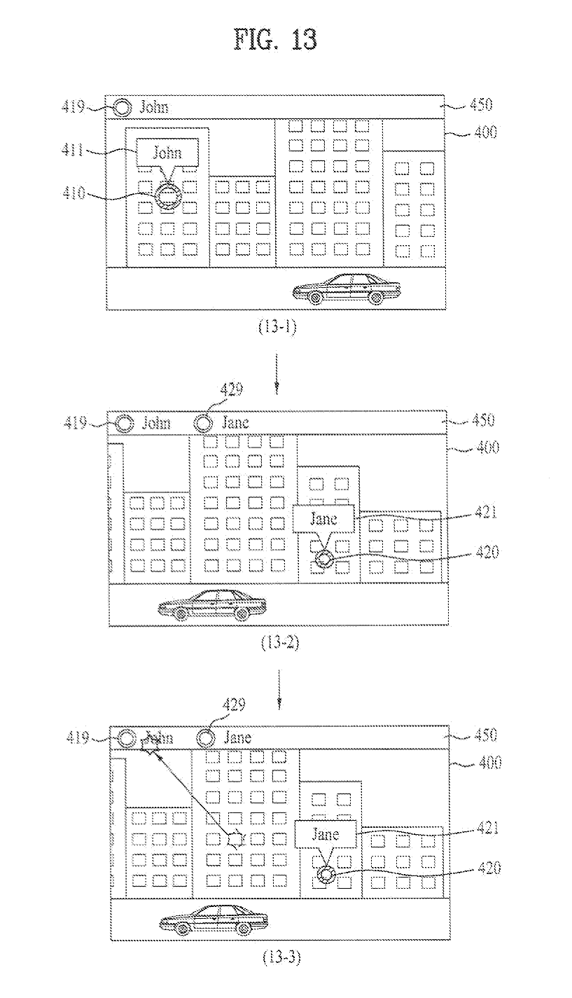

The following description is made with reference to FIG. 13.

Referring to FIG. 13 (13-1), the camera preview image is being displayed on the touchscreen 400 and a first counterpart indicator 410 is being displayed in the displayed camera preview image. Moreover, the capture region 450 described in the foregoing description can be provided to the touchscreen 400.

When the first counterpart indicator 410 is displayed in the camera preview image, the controller 180 controls a first counterpart to be automatically captured. And, the controller 180 is able to control a first counterpart capture indicator 419, which corresponds to the captured first counterpart, to be displayed in the capture region 450.

As the mobile terminal 100 is panned, for example, to adjust its orientation direction, a direction faced by the camera module 121 can be adjusted. In this case, referring to FIG. 13 (13-2), a new camera preview image according to the adjusted direction faced by the camera module 121 can be displayed on the touchscreen 400.

As the new camera preview image is displayed, the first counterpart indicator 410 can disappear from the touchscreen 400. Despite that the first counterpart indicator 410 has disappeared, the first counterpart capture indicator 419 can keep being displayed in the capture region 450.

As the mobile terminal 100 is panned, if a second counterpart indicator 420 newly appears in the new camera preview image from the mobile terminal 100, the controller 180 controls a second counterpart to be automatically captured.

Afterwards, referring to FIG. 13 (13-2), the controller 180 is able to control a second counterpart capture indicator 429, which corresponds to the captured second counterpart, to be displayed in the capture region 450.

In this case, the first counterpart capture indicator 419 and the second counterpart capture indicator 429 are sorted in a time order of capturing the counterparts and can be displayed in the capture region 450.

Alternatively, the first counterpart capture indicator 419 and the second counterpart capture indicator 429 are sorted in a distance order of spacing the counterparts apart from the mobile terminal 100 and can be displayed in the capture region 450.

As mentioned in the foregoing description, although the first counterpart indicator 410 is not displayed in the new camera preview image, if the first counterpart capture indicator 419 is touched and selected for example, it is able to control a menu list for the first counterpart to be displayed.

Referring to FIG. 13 (13-3), as the camera preview image is touched and then dragged to the first counterpart capture indicator 419 (or the first counterpart capture indicator 419 is touched and then dragged to the camera preview image), the controller 180 is able to control at least one of the camera preview image and current location information of the mobile terminal 100 to be transmitted to the first counterpart.

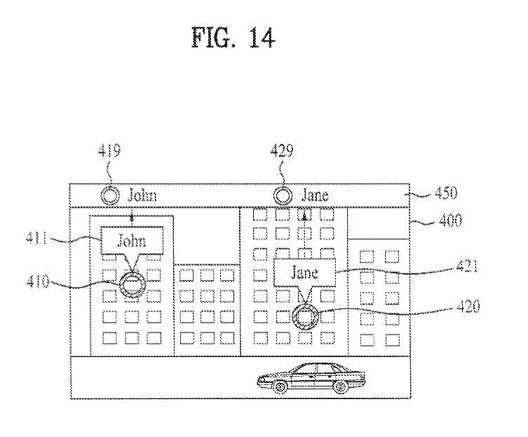

The following description is made with reference to FIG. 14.

Referring to FIG. 14, the camera preview image is being displayed on the touchscreen 400 and a first counterpart indicator 410 and a second counterpart indicator 420 are being displayed in the displayed camera preview image. Moreover, the capture region 450 described in the foregoing description can be provided to the touchscreen 400.

Afterwards, a user command for capturing first and second counterparts can be inputted via the user input unit 130. In this case, the user command for capturing counterparts can include a double-touch performed in a manner of double-touching each of the first and second counterpart indicators. Alternatively, the user command for capturing counterparts can include a shutter manipulation for photographing the camera preview image.

If so, the controller 180 captures the first and second counterparts and is then able to display corresponding indicators of the captured counterparts, i.e., a first counterpart capture indicator 419 and a second counterpart capture indicator 429 in the capture region 450. When the first and second counterparts are captured, the first counterpart capture indicator 419 and the second counterpart capture indicator 429 can be displayed at corresponding positions within the capture region 450 closest to the first counterpart indicator 410 and the second counterpart indicator 420, respectively.

Referring to FIG. 14, the first counterpart capture indicator 419 is displayed directly above the first counterpart indicator 410 in the capture region 450. And, the second counterpart capture indicator 429 is displayed directly above the second counterpart indicator 420 in the capture region 450.

Accordingly, the present invention provides the following effects and/or advantages.

First of all, according to at least one of embodiments of the present invention, it is able to provide a terminal user with information indicating whether a pre-registered counterpart exists in a preview image displayed in the course of image photographing.

It will be apparent to those skilled in the art that various modifications and variations can be specified into other forms without departing from the spirit or scope of the inventions.

In addition, the above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the controller 180 of the terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a user input unit;
a wireless communication unit;
at least one camera module;
a touchscreen configured to display a camera preview image;
a position-location module configured to obtain information on a current location of the mobile terminal; and
a controller controlling a counterpart indicator to be displayed in the camera preview image based on the current location of the mobile terminal, wherein the counterpart indicator indicates that at least one pre-registered counterpart exists within the camera preview image.

2. The mobile terminal of claim 1, wherein the controller controls the counterpart indicator to be displayed in the camera preview image in a manner of corresponding to a location where the counterpart exists.

3. The mobile terminal of claim 1, wherein the controller controls the counterpart indicator to be displayed in a manner of being visually distinguishable according to a spaced distance between the counterpart and the current location.

4. The mobile terminal of claim 1, wherein the controller controls the counterpart indicator to be displayed in a manner of being visually distinguishable according to a group to which the pre-registered counterpart belongs.

5. The mobile terminal of claim 1, wherein the controller controls the camera preview image to be captured and wherein the counterpart indicator is displayed in the camera preview image.

6. The mobile terminal of claim 5, wherein when the camera preview image is captured, the controller controls the camera module to be deactivated.

7. The mobile terminal of claim 1, wherein the controller captures only the counterpart indicator in the camera preview image, and wherein after the counterpart indicator has been captured, when an orientation direction of the mobile terminal is adjusted, the controller controls the captured counterpart indicator to be displayed in a new camera preview image according to the adjusted orientation direction.

8. The mobile terminal of claim 1, wherein the controller controls the counterpart indicator to be displayed if the counterpart indicator corresponds to the pre-registered counterpart in a first distance from the current location within the camera preview image.

9. The mobile terminal of claim 8, wherein when a prescribed user command is inputted, the controller controls the counterpart indicator to be displayed if the counterpart indicator corresponds to the pre-registered counterpart in a second distance farther than the first distance from the current location within the camera preview image.

10. The mobile terminal of claim 8, wherein when a prescribed user command is inputted, the controller controls the counterpart indicator to be displayed if the counterpart indicator corresponds to the pre-registered counterpart in a second distance farther than the first distance from the current location within the camera preview image in a manner of maintaining a zoom of the camera preview image.

11. The mobile terminal of claim 8, wherein the counterpart indicator comprises a photo of the counterpart registered with a phonebook.

12. The mobile terminal of claim 11, wherein if the photo of the counterpart is not registered with the phonebook, the controller controls the photo of the counterpart to be downloaded by accessing a website via the wireless communication unit.

13. The mobile terminal of claim 12, wherein the website comprises an SNS (social network service) network.

14. The mobile terminal of claim 1, wherein the controller controls to an IM (instant message) counterpart list to be further displayed on the touchscreen and wherein if the indicator is touched and then dragged to the IM counterpart list, the controller controls the counterpart to be included in the IM counterpart list.

15. The mobile terminal of claim 14, wherein if a prescribed touch gesture is performed on the IM counterpart list, the controller controls an IM window for an instant message (IM) with at least one counterpart in the IM counterpart list to be displayed.

16. The mobile terminal of claim 15, wherein when an IM is received from a different counterpart in the course of the IM communication with the counterpart, the controller controls the received IM to be displayed separate from the IM window.

17. The mobile terminal of claim 16, wherein the controller controls the received IM to be displayed in a manner of corresponding to a location of the different counterpart.

18. The mobile terminal of claim 1, wherein the controller controls the counterpart indicator of the counterpart seen from the camera preview image to be visually distinguishable from the counterpart indicator of the counterpart unseen from the camera preview image.

19. The mobile terminal of claim 1, wherein the controller controls the counterpart indicator of the counterpart seen from the camera preview image to be displayed above the counterpart.

20. A method of controlling a mobile terminal, comprising:
displaying a camera preview image; and
if information on a current location of the mobile terminal is obtained, displaying a counterpart indicator in the camera preview image based on the current location of the mobile terminal, wherein the counterpart indicator indicates that at least one pre-registered counterpart exists within the camera preview image.
